(19) United States
(12) Patent Application Publication
(10) Pub. No.: US 2012/0090027 A1
(43) Pub. Date: Apr. 12, 2012

(54) APPARATUS AND METHOD FOR DETECTING ABNORMAL HOST BASED ON SESSION MONITORING

(75) Inventors: Seon-Gyoung SOHN, Daejeon (KR); Beom Hwan CHANG, Daejeon (KR)

(73) Assignee: Electronics and Telecommunications Research Institute, Daejeon (KR)

(21) Appl. No.: 13/271,598

(22) Filed: Oct. 12, 2011

(30) Foreign Application Priority Data
Oct. 12, 2010 (KR) 10-2010-0099208
Mar. 16, 2011 (KR) 10-2011-0023392

(51) Int. Cl. G06F 21/20; G06F 11/30

(52) U.S. Cl. 726/22

(57) ABSTRACT

An apparatus for detecting an abnormal host based on session monitoring includes: a host information collection unit for collecting information of processes being executed in hosts and information of sessions connected by the hosts; a network traffic monitoring unit for collecting network traffic information; an analysis unit for calculating an entropy of each host based on the collected session information to analyze correlation between hosts based on the calculated entropy and the network traffic information; and a detection unit for detecting an abnormal host and a process causing harmful traffic in the abnormal host based on the correlation and updating a black list based on the detected host and process.

### CROSS-REFERENCE(S) TO RELATED APPLICATION(S)

The present invention claims priority of Korean Patent Application Nos. 10-2010-0099208, filed on Oct. 12, 2010 and 10-2011-0023392, filed on Mar. 16, 2011, which are incorporated herein by reference.

### FIELD OF THE INVENTION

The present invention relates to abnormal host detection, and more particularly, to an apparatus and method for detecting an abnormal host based on session monitoring which are capable of detecting an abnormal host by associatively analyzing session information collected from hosts and network traffic information.

### BACKGROUND OF THE INVENTION

A conventional abnormal phenomenon detection technique may be divided into a network-based one for detecting abnormal traffic by analyzing network traffic on a packet or flow basis and a host-based one for detecting an abnormal phenomenon by analyzing host processes and resources.

In the network-based abnormal phenomenon detection technique, although abnormal traffic detected by the technique is cut off, if a host which is generating abnormal traffic continuously operates, the abnormal traffic would be continuously generated, thereby causing an abnormal phenomenon in a network.

The host-based abnormal phenomenon detection technique is capable of accurately detecting an incident which actually takes place, but it is system-dependent and has difficulty in analyzing a behavior related to a network.

### SUMMARY OF THE INVENTION

In view of the above, the present invention provides an apparatus for detecting an abnormal host based on session monitoring, which detects a host and a process causing an abnormal phenomenon by determining whether a destination host of a collected session and/or a process of a source host of the session are included in a harmful process/host list and associatively analyzing network traffic information.

In accordance with an aspect of the present invention, there is provided an apparatus for detecting an abnormal host based on session monitoring, the apparatus including:

a host information collection unit for collecting, from an external agent, information of processes being executed in hosts and information of sessions connected by the hosts;

a network traffic monitoring unit for collecting network traffic information;

an analysis unit for calculating an entropy of each host based on the collected session information to analyze correlation between hosts based on the calculated entropy and the network traffic information; and

a detection unit for detecting an abnormal host and a process causing harmful traffic in the abnormal host based on the correlation and updating a black list which stores a harmful process list and a harmful host list based on the detected host and process.

In accordance with another aspect of the present invention, there is provided a method for detecting an abnormal host based on session monitoring, the method including:

collecting, from an external agent, information of processes being executed in hosts and information of sessions connected by the hosts;

updating, when a destination host of a session in the collected session information is included in a black list which stores a harmful host list and a harmful process list, the black list by adding a source host of the session and a process executed by the source host to the black list;

calculating an entropy of each host based on the collected session information to analyze correlation between hosts based on the calculated entropy and network traffic information;

detecting an abnormal host based on the correlation; and

updating the black list by adding the abnormal host and a process causing harmful traffic in the abnormal host to the black list.

### BRIEF DESCRIPTION OF THE DRAWINGS

The objects and features of the present invention will become apparent from the following description of embodiments, given in conjunction with the accompanying drawings, in which:

FIG. 1 illustrates a block diagram of an apparatus for detecting an abnormal host based on session monitoring in accordance with an embodiment of the present invention; and

FIG. 2 is a flow chart illustrating a process of detecting an abnormal host in accordance with the embodiment of the present invention.

### DETAILED DESCRIPTION OF THE EMBODIMENT

Hereinafter, an embodiment of the present invention will be described in detail with the accompanying drawings.

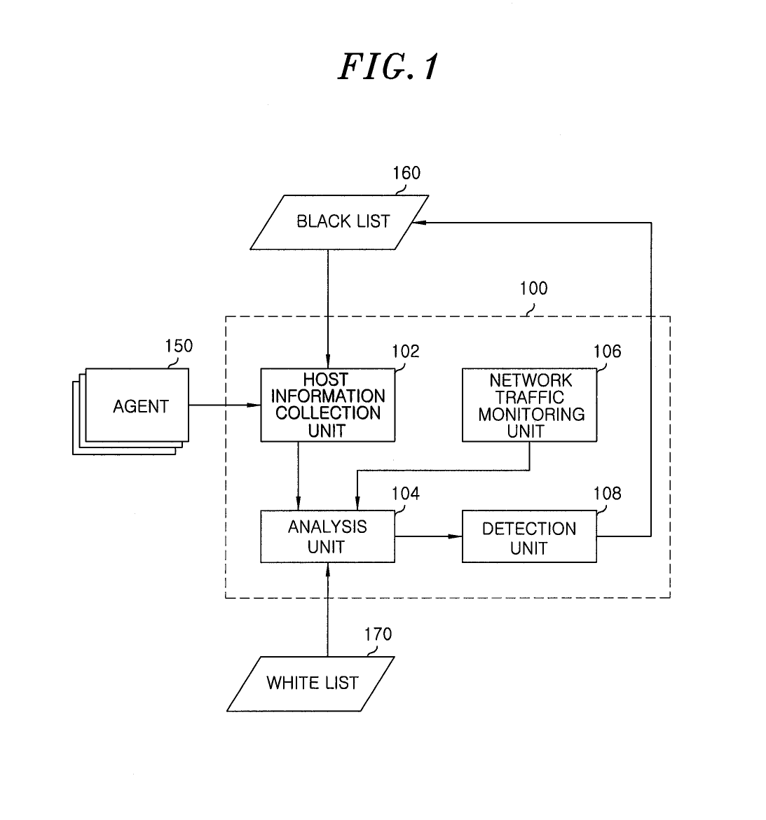

FIG. 1 illustrates a block diagram of an apparatus for detecting an abnormal host based on session monitoring in accordance with an embodiment of the present invention.

Referring to FIG. 1, the abnormal host detection apparatus 100 includes a host information collection unit 102, a network traffic monitoring unit 106, an analysis unit 104, and a detection unit 108 and detects an abnormal host by interworking with an external black list 160 and an external white list 170.

The black list 160 used in the embodiment of the present invention stores a harmful host list, a harmful process list and the like. The white list 170 stores a stable host list which is a list of reliable hosts such as a mail server, a DNS server, a Web server, or the like, and such a host list may be manually managed by a manager.

The host information collection unit 102 of the abnormal host detection apparatus 100 collects, from an agent 150, information of processes being executed in hosts and information of sessions connected by the hosts. Further, the host information collection unit 102 checks whether or not a destination host of each session in the collected session information is included in the harmful host list by searching the black list 160.

Further, the host information collection unit 102 compares a process of a source host of each session to processes of the harmful process list stored in the black list 160 to recognize such a behavior that a corresponding session tries to attack the network, a host infected with a malicious code communicates with a command-and-control (C&C) server, or the like. Based on the recognition, the host information collection unit 102 updates the black list 160 storing the harmful process list and the harmful host list. For example, when the source host is not included in the black list 160 but the destination host in the session information is included in the black list 160, the host information collection unit 102 determines the source host and the process performing the corresponding session as a harmful host and a harmful process, respectively and updates the black list 160.

The updating of the black list 160 by the host information collection unit 102 may be temporary, and a final updating of the black list 160 may be performed when the source host is detected as an abnormal host through a final analysis to be described later.

Meanwhile, when there are a large number of hosts that need to be managed by the host information collection unit 102, the host information collection unit 102 may be hierarchically configured.

The network traffic monitoring unit 106 collects network traffic, classifies the collected network traffic by host/protocol/service, and monitors an abnormal phenomenon of the network traffic.

The analysis unit 104 extracts relationships between the hosts by using the collected session information, calculates an entropy of each host, extracts a host whose calculated entropy is abnormally higher than those of other hosts, and then compares the extracted host to the stable hosts stored in the white list 170.

Although the extracted host exists in the white list 170, if the host is connecting a session to a process included in the harmful process list within the black list 160, the analysis unit 104 takes the extracted host as an analysis target. In this case, the analysis unit 104 compares the extracted host to a host causing abnormal network traffic and analyzes their correlation.

The detection unit 108 detects an abnormal host based on the analysis results of the analysis unit 104 and further detects a process causing harmful traffic in the detected abnormal host. The black list 160 is finally updated based on the detected host and process.

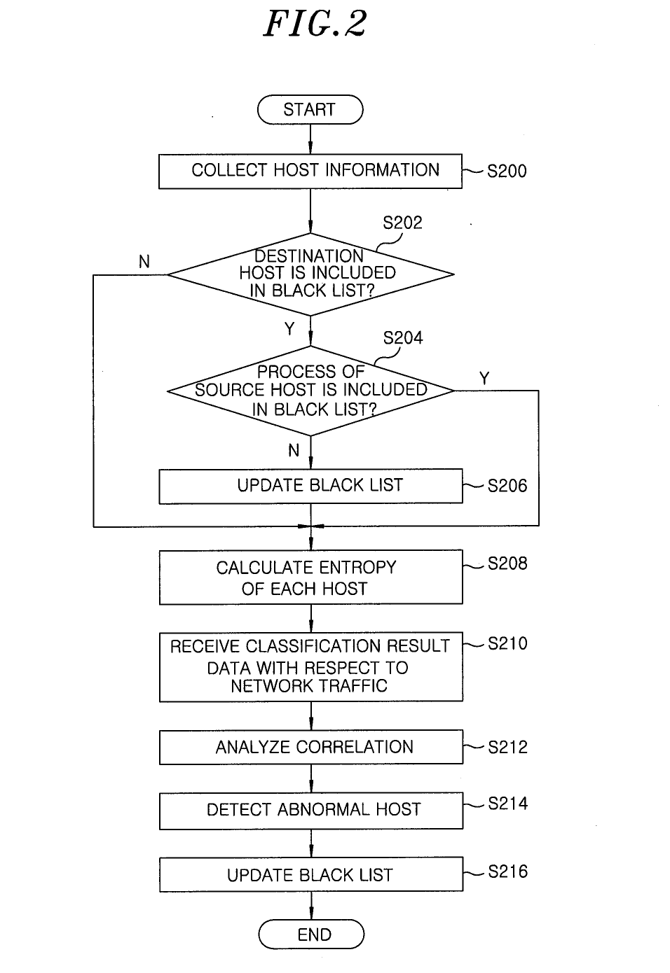

An operation process of the abnormal host detection apparatus 100 having the foregoing configuration will now be described with reference to FIG. 2.

FIG. 2 is a flow chart illustrating a process of detecting an abnormal host in accordance with the embodiment of the present invention.

As shown in FIG. 2, the host information collection unit 102 collects information of hosts from the agent 150 in step S200. Specifically, the host information collection unit 102 collects information of processes being executed in the hosts and information of sessions connected by the hosts. Next, the host information collection unit 102 compares a destination host of each session in the collected session information to the harmful host list stored in the black list 160 to thereby determine whether or not the destination host is included in the harmful host list in step S202.

When it is determined in step S202 that the destination host is included in the harmful host list, the host information collection unit 102 determines whether or not a process of a source host of the corresponding session is included in the harmful process list of the black list 160 in step S204. Here, the process of the source host of the session may be executed for communication with the destination host.

When it is determined in step S204 that the process of the source host is not included in the harmful process list, the host information collection unit 102 updates the black list 160 by adding the process of the source host to the harmful process list in step S206, and recognizes such a behavior that the corresponding session tries to attempt a network attack, a host infected with a malicious code communicates with a C&C server, or the like.

Next, the analysis unit 104 extracts connection relationships between the hosts by using the collected session information, and then calculates an entropy of each host in step S208.

In step S210, the analysis unit 104 receives result data obtained by classifying the collected network traffic by host/protocol/service from the network traffic monitoring unit 106. Then in step S212, the analysis unit 104 extracts a host whose calculated entropy is abnormally higher than those of other hosts and compares the extracted host to a host causing abnormal network traffic, thereby analyzing their correlation. The correlation analysis result is provided to the detection unit 108.

The detection unit 108 detects an abnormal host based on the provided correlation analysis result, and further detects a process causing harmful traffic from the detected abnormal host in step S214. Thereafter, the detection unit 108 updates the black list 160 by adding the detected process and host to the black list 160 in step S216.

When it is determined in step S202 that the destination host is not included in the harmful host list, or when it is determined in step S204 that the process of the source host is included in the harmful process list, step S208 and subsequent steps are performed.

In accordance with the embodiment of the present invention, the session information collected from the hosts and the network traffic information are associatively analyzed to thereby detect a host and a process causing an abnormal phenomenon in a network. Further, a harmful process list and a harmful host list are updated based on the detection result, thus reducing an erroneous detection rate and a non-detection rate.

Also, in accordance with the present invention, when the reliability of a host is evaluated, a stable host list is compared as well as a harmful host list, thus making more accurate evaluation.

While the invention has been shown and described with respect to the embodiments, it will be understood by those skilled in the art that various changes and modification may be made without departing from the scope of the invention as defined in the following claims.

What is claimed is:

1. An apparatus for detecting an abnormal host based on session monitoring, the apparatus comprising:
a host information collection unit for collecting, from an external agent, information of processes being executed in hosts and information of sessions connected by the hosts;
a network traffic monitoring unit for collecting network traffic information;
an analysis unit for calculating an entropy of each host based on the collected session information to analyze correlation between hosts based on the calculated entropy and the network traffic information; and
a detection unit for detecting an abnormal host and a process causing harmful traffic in the abnormal host based on the correlation and updating a black list which stores a harmful process list and a harmful host list based on the detected host and process.

2. The apparatus of claim 1, wherein the host information collection unit, when a destination host of a session in the collected session information is included in the black list, updates the black list by adding a source host of the session and a process executed by the source host to the black list.

3. The apparatus of claim 1, wherein the network traffic monitoring unit classifies the collected network traffic information by host, protocol, or service and monitors an abnormal phenomenon of the network traffic.

4. The apparatus of claim 1, wherein the analysis unit extracts a host whose calculated entropy is abnormally higher than those of other hosts, and compares, when the extracted host is connecting a session with a process included in the harmful process list of the black list, the extracted host to a host causing abnormal network traffic to thereby analyze their correlation.

5. A method for detecting an abnormal host based on session monitoring, the method comprising:
collecting, from an external agent, information of processes being executed in hosts and information of sessions connected by the hosts;
updating, when a destination host of a session in the collected session information is included in a black list which stores a harmful host list and a harmful process list, the black list by adding a source host of the session and a process executed by the source host to the black list;
calculating an entropy of each host based on the collected session information to analyze correlation between hosts based on the calculated entropy and network traffic information;
detecting an abnormal host based on the correlation; and
updating the black list by adding the abnormal host and a process causing harmful traffic in the abnormal host to the black list.

6. The method of claim 5, wherein said analyzing the correlation between hosts includes:
extracting a host whose calculated entropy is abnormally higher than those of other hosts; and
comparing, when the extracted host is connecting a session with a process included in the harmful process list of the black list, the extracted host to a host causing abnormal network traffic to thereby analyze their correlation.
